(19) United States
(12) Patent Application Publication
(10) Pub. No.: US 2023/0180942 A1
(43) Pub. Date: Jun. 15, 2023

(54) Posture Correcting Traction Sleeping Pillow

(71) Applicant: Cedric Thelonious Macillian Walker

(72) Inventor: Cedric Thelonious Macillian Walker, San Francisco, CA (US)

(21) Appl. No.: 17/944,921

(22) Filed: Sep. 14, 2022

Related U.S. Application Data
(60) Provisional application No. 63/360,223, filed on Sep. 16, 2021.

(51) Int. Cl. A47C 27/14; A47G 9/10

(52) U.S. Cl. CPC A47C 27/144; A47G 9/1081

(57) ABSTRACT

A traction pillow for creating gravity induced traction across the upper anterior region of the torso to stretch the muscles residing in that region. Tightening muscles caused by unhealthy posture and sleeping habits can cause musculoskeletal system imbalances, which can lead to chronic pain and or degenerative disease. Imbalances across the upper torso region can further cause rounded shoulders. An underpinning underlay orients a torso support and a neck and head support along an inclined plane to properly align the lumbar, thoracic, and cervical spines of a supine resting body and to gradually elevate the torso, neck, and head above a horizontal resting surface to enable the outer extremities of the upper torso, not supported by the torso support, to be pulled downward by the force of gravity and droop unobstructed above the horizontal resting surface. The torso is generally of a higher weight in comparison to the combined weight of the head and neck. Therefore, the mechanical properties - i.e., bulk moduli - of the materials used to construct the torso support, the neck and head support, and the underpinning underlay are independently formulated to provide appropriate levels of individual firmness, and to enable the torso support and the neck and head support to volumetrically compress in lockstep to maintain spinal alignment throughout compression.

### BACKGROUND

Good posture is important for the health of our musculoskeletal system. The human musculoskeletal system is essentially an organ system that gives humans the ability to move through the flexion and extension of their muscles and the subsequent articulation of their skeletal system. Holistically, the musculoskeletal system provides form, support, stability, and movement to the body. Imbalances in our musculoskeletal system, caused by poor posture, are a primary cause of musculoskeletal pain. It can manifest as typical neck and lower back pain, upper back and shoulder pain, forearm and hip pain, and in some cases as headaches that sometimes extend into the jaw.

Our daily and nightly routines can be contributors that lead to poor posture. How we sit and or how we engage our computers during a typical day can be leading culprits. What might be surprising to some, and is the motivation for the invention being presenting, is that our nightly routines while we sleep may have more influence over how well we safeguard our posture and musculoskeletal health. This is because during this period of rest we are not conscious and therefore don’t have control over our bodily movements. The unfortunate reality is that this can put our musculoskeletal health at risk because many of us don’t naturally sleep in positions that protect musculoskeletal alignment and balance.

To date, methods prescribed to avoid and guard against musculoskeletal system imbalances require active-conscious participation, meaning that the participant must be awake and conscious in order to implement the prescription. For example, a participant would be required to constantly monitor their sitting position to avoid slipping into an unbalanced musculoskeletal position while seated, and to take immediate action to correct the imbalance when and if such an event occurred. Conversely, no effort has been made, with perhaps the exception of the cervical contoured pillow, to apply similar proactive practices or implement helpful sleeping aids when the participant is asleep and unconscious. On average, we spend a third of each day sleeping. This means for about 8 hours a day, our bodies are potentially exposed and unprotected against unhealthy sleeping habits that can encourage or further aggravate existing musculoskeletal imbalances.

Long term imbalances in the musculoskeletal system can lead to chronic pain and or degenerative diseases. For this reason, attention must be given to guarding against these likely unhealthy sleeping habits in order to increase the likelihood of achieving sustained long-term musculoskeletal health. Key to achieving and maintaining musculoskeletal balance is having a neutral spine. A neutral spine is the position in which the back and neck are placed under the least amount of stress and strain, allowing each to perform their function properly without damage and, therefore, without pain. Present in a healthy neutral spine are what is known as the “three natural curves,” which is a reference to the inherent natural curvatures belonging to the cervical spine section, the thoracic spine section, and the lumbar spine section. A neutral spine, also referred to as spinal neutrality, is achieved when all three spinal sections, while maintaining their respective natural curvature, are also in proper alignment with respect to each other.

There are several causes for a neutrally balanced spinal system going into misalignment: poor daily and nightly habits, apparatuses that provide poor spinal support, are just a few. Misalignment can lead to symptoms such as rounded shoulders, where the shoulders are rotated forward. This condition, in effect, shortens the lateral distance across the anterior region of the upper torso between the outer shoulders. When this occurs, the distance in which the anterior muscles of the upper torso must function also shortens. Left uncorrected, these muscles will progressively begin to physically shorten over time, making the condition chronic. Conversely, and at the same time, the lateral distance across the posterior region of the upper torso increases. Consequently, this reciprocal increase in lateral distance elongates the posterior muscle group of the upper torso making them less efficient in their utility by requiring these muscles to contract or function across a longer distance to achieve the same mechanical result that would have been otherwise realized by a properly balanced posterior muscle group.

When we sleep, our bodies tend to contorts, twists, and bends in ways that we cannot consciously control. For example, when sleeping on our back, the natural alignment between the cervical, thoracic, and lumbar spines can become compromised. Traditional pillows, including some contoured pillows, don’t necessary work integrally with traditional beds and or mattresses to maintain healthy alignment between the lumbar, thoracic, and cervical spines. When this occurs, surrounding tense muscles can easily pulled vulnerable sections of the spine into misalignment. If the spine is misaligned, the weight of the body, including that of the head, will not properly distribute across the lumbar, thoracic, and cervical spines, causing in certain instances some of the vertebrae to become compressed. Overtime, this can lead to degenerative diseases. It is vitally important, when sleeping, that the natural curvature of the three spinal sections are maintained and that these three sections are also integrally aligned to function as a group that maintains neutral alignment such that the musculoskeletal system can remain in healthy balance.

When skeletal misalignment and or musculoskeletal imbalance occurs, chiropractors and physical therapists, as a first step, employ techniques to reestablish balance. This includes adjustments to the skeletal system and applying therapy to recondition tense muscles to work optimally with the skeletal system. This is typically followed by prescribing, when appropriate, exercises that are outside doctor’s care, to help hold or maintain these adjustments in order to promote and sustain a healthy and balanced musculoskeletal system.

Chiropractors and physical therapists employ several methods for regaining and maintaining a healthy and balanced musculoskeletal system. For instance, some chiropractors use a cylinder shaped neck roll to treat cervical compression and encourage the natural curvature of the cervical spine. Similarly, treating pinched cervical nerves that cause numbness in the arms, wrists, and hands, a technique used by some physical therapists employ a relatively large foam cylinder for suspending the shoulders above a horizontal surface, such as a floor. The patient lies on the foam cylinder, such that the cylinder extends along the length of the spinal column, from the hips to the tip of the head. As a result, the shoulders are left to freely hang above the floor with the goal being to “opens the path” of the nerves from the neck to the outer extremities of hands, so as to eliminate or at lease mitigate any pressures acting on the nerves. As a consequence, and the primary motivation for the present invention, this technique also allows gravity to pull the shoulders downward to create lateral traction across the upper anterior region of the torso, thus causing the anterior muscles in this region to be stretched.

Furthermore, the elongated posterior muscles in the upper torso also benefit from this technique in that the posterior distance between the shoulders is shorten, thereby allowing these muscles to retract. It is important to note that this technique requires the patient to be awake and conscious to maintain balance on the cylinder - i.e., prevent lateral roll caused by a patient’s weight shifting too much to either side of the cylinder.

An innovative solution that can apply these techniques while the person sleeps can make a powerful and positive contribution to musculoskeletal health.

### DISADVANTAGES

The current state of the art focuses on alignment of the head and neck only. The disadvantages associated with the current state of the art are as follows:
A disadvantage of the current state of the art is that it does not collectively orient the lower and upper regions of the torso, the neck, and the head to minimize the amount of stress and subsequent strain being applied to the lumbar, thoracic and cervical spines while a person is sleeping;
Another disadvantage of the current state of the art is that it does not laterally stretch the anterior muscles of the upper torso while a person is sleeping;
Yet another disadvantage of the current state of the art is that does not orient the shoulders such that the posterior muscles of the upper torso, when in a relaxed state, can retract while a person is sleeping;
An additional disadvantage of the current state of the art is that it does not enable the anterior and the posterior muscles of the upper torso to neutrally balance while a person is sleeping;
Still an additional disadvantage of the current state of the art is that it does not optionally cool the posterior regions of the upper torso while a person is sleeping;
Therefore there is a need in the art for a sleeping device that does not suffer from the disadvantages noted above.

### OBJECTS AND SUMMARY OF THE INVENTION

The principal object of the present invention is to provide a sleeping pillow for sleeping in a bed or on a similar surface that establishes and maintains healthy spinal alignment and applies traction across the upper anterior torso to effectively stretch the muscles in that region to extend their length and enable the posterior muscles of the upper torso to retract. The goal is to achieve musculoskeletal balance in the torso and neck regions of the body to ultimately condition and or train the body to involuntarily maintain a healthy posture throughout a typical day.
An object of the present invention is to provide a sleeping pillow that supports and positions the head, neck, and torso, such that the cervical spine, the thoracic spine, and lumbar spine are in proper alignment while sleeping;
Another object of the present invention is to provide a sleeping pillow that creates gravity assisted lateral traction across the upper anterior torso to help balance the musculoskeletal region of the upper torso and encourage healthy posture while sleeping;
Yet another object of the present invention is to provide a sleeping pillow that enables the posterior muscles of the upper torso to retract towards equilibrium while sleeping;
An additional object of the present invention is to provide a sleeping pillow that cools posterior regions of the upper torso, while sleeping;
Still another additional object of the present invention is to provide a sleeping pillow that can be scaled to support different ranges of weights or weight classifications;
Still yet another additional object of the present invention is to provide a sleeping pillow that has a removable exterior cover for easy cleaning and maintenance;
A further object of the present invention is to design this sleeping pillow to be simple in construction, easy to use, and relatively inexpensive to manufacture.

In summary, the main object of the present invention is to enable spine neutrality across the cervical, thoracic and lumbar spines, to neutrally balance the anterior and posterior muscles of the upper torso, and cool posterior regions of the upper torso.

### BRIEF DESCRIPTION OF DRAWINGS

The above and the other objects and advantages and novel features of the present invention will become apparent from the following detailed description of the embodiment of the invention illustrated in the accompanied drawings, wherein:

FIG. 1 is a front right perspective of the present invention;

FIG. 2a is a right elevational view that of a person preparing to lay on the support surfaces of the present invention shown in FIG. 1;

FIG. 2b is a right elevational view of a person laying on the support surfaces of the present invention shown in FIG. 1;

FIG. 3 is a right cross sectional view generally taken along centerline-axis Y of the present invention shown in FIG. 1 that illustrates the relations between reference plane A, reference plane Aₚᵣᵢₘₑ, and reference plane Aₘₐₓ.

FIG. 4 is a right elevational exploded view of the present invention shown in FIG. 1;

FIG. 5 is an isolated rear right perspective view of the cooling system of the present invention shown in FIG. 1;

FIG. 6 is a right elevational partially exploded view of the present invention shown in FIG. 1;

FIG. 7 is a lower rear right partial perspective view of the torso support part of the present invention shown in FIG. 1;

FIG. 8 is a front perspective view of the present invention shown in FIG. 1;

FIG. 9 is a front right partial perspective view of the underlay part of the present invention shown in FIG. 1;

FIG. 10 is a right lower exploded perspective view of the torso support part and underlay part of the present invention shown in FIG. 1;

FIG. 11 is a right elevational view of the present invention shown in FIG. 1;

FIG. 12 is a front right partial perspective view of the internal ducts of the underlay part of the present invention shown in FIG. 1;

FIG. 13 is a top partial elevational view of the torso support part of the present invention shown in FIG. 1;

FIG. 14 is a right upper exploded perspective view of the torso support part and an alternative version of underlay part of the present invention shown in FIG. 1;

FIG. 15 is a rear elevational view of the present invention shown in FIG. 1;

FIG. 16 is a front right perspective of the present invention shown in FIG. 1 joined with a conventional mattress;

### DETAILED DESCRIPTION OF THE INVENTION

### I. Definitions

In this disclosure, the listed terms will be defined as follows:

Reference plane A is an inclined reference plane proxy that represents the position of the uncompressed support surfaces acting along uncompressed angle α_{uca} of the present invention.

Reference plane Aₚᵣᵢₘₑ or A′ is an inclined reference plane proxy that represents the position of the support surfaces acting along compressed angle α_{ca} of the present invention when compressed.

Reference plane Aₘₐₓ or AM is an inclined reference plane proxy acting along maximum compressed angle α_{mca} that represents, for a given body weight, the maximum compressed positions geometrically allowed for the support surfaces of the present invention. As such, Reference plane Aₘₐₓ establishes the geometric range within which the mechanical properties of the materials used to construct the support components must operate to keep the upper torso at or above a specific height, relative to a horizontal surface, in order to maintain gravity induced traction across the upper anterior torso during compression.

Density of a foam is its mass per unit volume. Density may be measured in pounds per cubic foot (pcf).

Indentation Force Deflection (IFD) is a method for determining the firmness and load bearing capacity of foam. IFD measures the load required to depress a compression platen into a foam specimen. IFD is normally reported as 25% deflection of the specimen’s height and is measured in pounds. IFD may be measured with ASTM D3574, Test B.

Support Factor (SF) is the quotient of 65% IFD over 25% IFD and is a unitless measurement. Support Factor is a measure of the “deeper” support of a foam, and is also known as Compression Modulus. SF may be measured with ASTM D3574, Test B. SF is an indicator as to whether a foam will bottom out or not.

Support Factor Ratio (SFR)_{torso/pillow}, a quotient, is the proportionality constant between the SF of the material specified to support a torso and the SF of the material specified to support a head and neck.

25% Indentation Force Deflection Ratio (IFDR)_{torso/pillow}, per ASTM D3574, Test B, is a proportionality constant between the IFD at 25% of the material specified to support a torso and the IFD at 25% of the material specified to support the head and neck.

Recovery is a measure of how quickly a foam returns to original shape after being displaced and is measured in seconds. Recovery is used to typically measure the memory effect of viscoelastic foams. Recovery may be measured with ASTM D3574, Test M.

Compressive Strength is the required pressure (pound per square inch) applied to a test sample that causes the test sample to fracture or deform. Compressive strength may be measured with ASTM D1621.

Latex foam is any resilience foam where a rebound may be greater than 40%. Latex foam may be natural latex, styrene butadience rubber (SBR), polyurethane or any blend of the above foams.

Foam-like foam is any foam intended to simulate the mechanical properties of latex foam.

Viscoelastic foam is any polyurethane foam with a delayed recovery and temperature-sensitive response. More specifically, the recovery may be greater than 1 second.

Formulation or to formulate is a procedure used when working with latex foam systems that applies a specific mix ratio of polyols to isocyanate chemicals to produce a customized latex foam composition having a specified bulk modulus.

Bulk Modulus (BM) is a measure of a material’s ability to volumetrically withstand changes in its volume or is able to pushback when under compression. BM is equal to the quotient of the applied pressure divided by the relative deformation (i.e., change in its volumetric thickness) and is expressed here in the equation: BM = σ/_{ε}, where σ describes stress in lb/ft² and ε describes strain in ft/ft.

Yield Point in material science and engineering is the point on a stress-strain curve that indicates the limit of elastic behavior and the beginning of plastic behavior. Below the yield point, a material will deform elastically when a stress is applied and will return to its original shape when that applied stress is removed.

Weight Bearing Ratio (WBR)_{torso/pillow}, is a quotient of the bulk modulus of the material that generally supports the weight of a torso divided by the bulk modulus of the material that generally supports the combined weight of a head and neck. Expressed here in the equation WBR_{torso/pillow} = PBWₜₒᵣₛₒ/PBW_{head-neck}, where PBWₜₒᵣₛₒ (the dividend) is the percentage of the total body weight that represents a weight of the torso and PBW_{head-neck} (the divisor) is the percentage of the total body weight that represents a weight of the head and neck. PBWₜₒᵣₛₒ is the combined weight of the abdomen, thorax, left and right shoulders, and upper left and right arms.

Preformulation is a premanufacturing methodology that employs WBR_{torso/pillow} a governing parameter for characterizing and establishing the mechanical properties (bulk moduli) of the materials used to construct the support components of the current invention for different weight classifications - e.g., small size person, medium size person, heavy size person, etc.

Bulk Modulus Boundary (BMB)_{torso/pillow}, is the quantitative relation between the bulk modulus of a material used to construct a torso support part and the bulk modulus of a material used to construct a head and neck support part.

Bulk Modulus Boundary (BMB)_{torso/underlay}, is the quantitative relation between the bulk modulus of a material used to construct a torso support part and the bulk modulus of a material used to construct an underlay part.

Bulk Modulus Boundary (BMB)_{pillow/underlay}, is the quantitative relation between the bulk modulus of a material used to construct a head and neck support part and the bulk modulus of a material used to construct an underlay part.

Outer Extremities of the Upper Torso is the encompassment of the outer regions of the upper torso which generally includes the outer anterior and posterior portions of the torso, the shoulders, and the upper arms.

### II. Traction Pillow

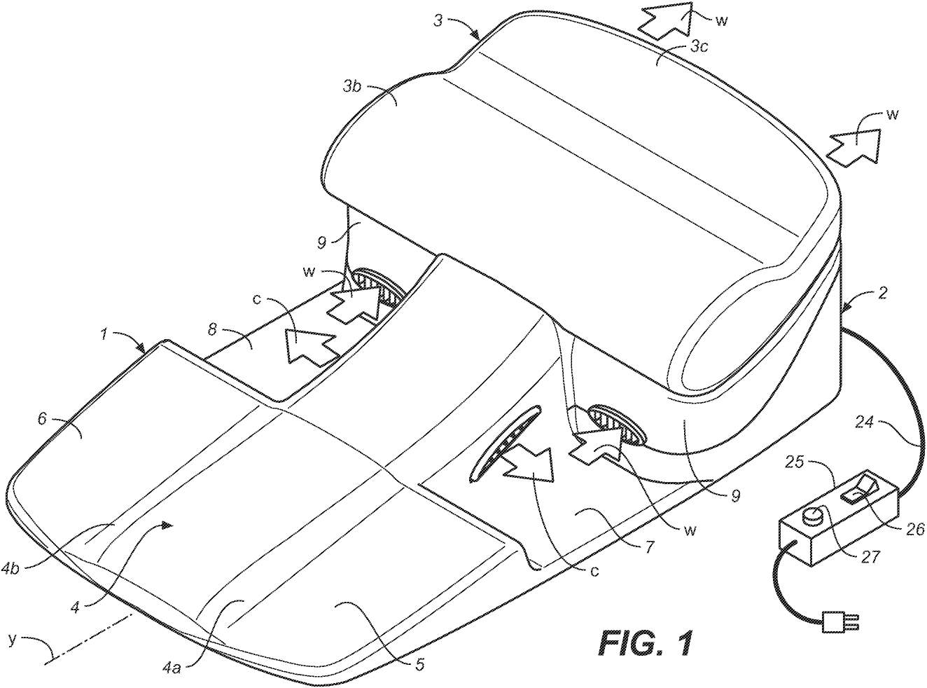

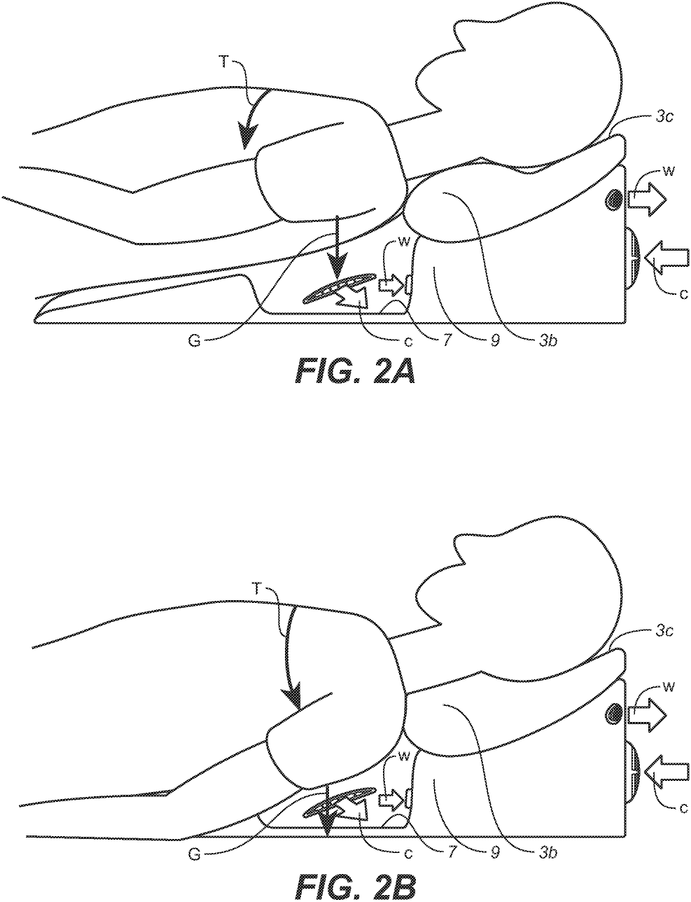

As best shown in FIG. 1, the traction pillow of the present invention exhibits a generally polyhedron wedge prism shape. The primary function of the traction pillow, as best shown in FIG. 2a, is to elevate the upper torso of a person’s body above a horizontal resting plane H such that the outer extremities of the upper torso including the shoulders and upper arms are, as best shown in FIG. 2b, suspended above an empty volume of space to allow gravity G to explicitly act on the unsupported outer extremities of the upper torso in a way that creates traction T across the upper anterior region of the torso and thereby stretch its upper anterior muscles.

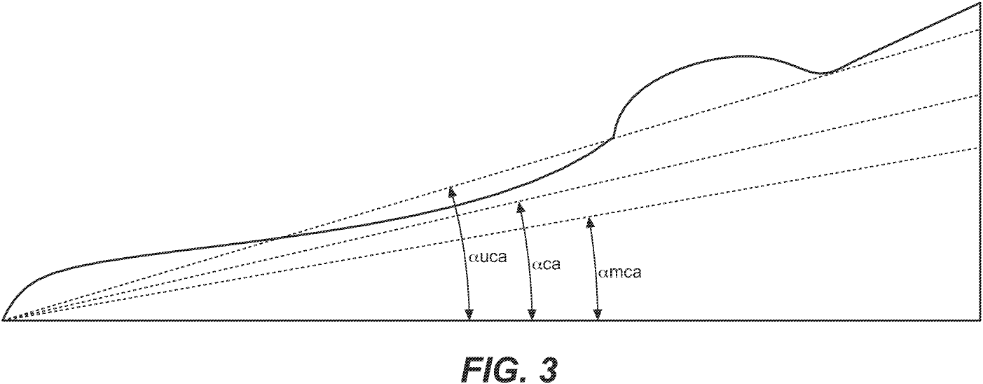

The support surfaces in contact with the torso, neck, and head, when acted upon by the weight of a resting body, will, as best shown in FIG. 3, compress vertically downward out of reference plane A. When this occurs, reference plane A transitions to reference plane Aₚᵣᵢₘₑ and compresses towards reference plane Aₘₐₓ.

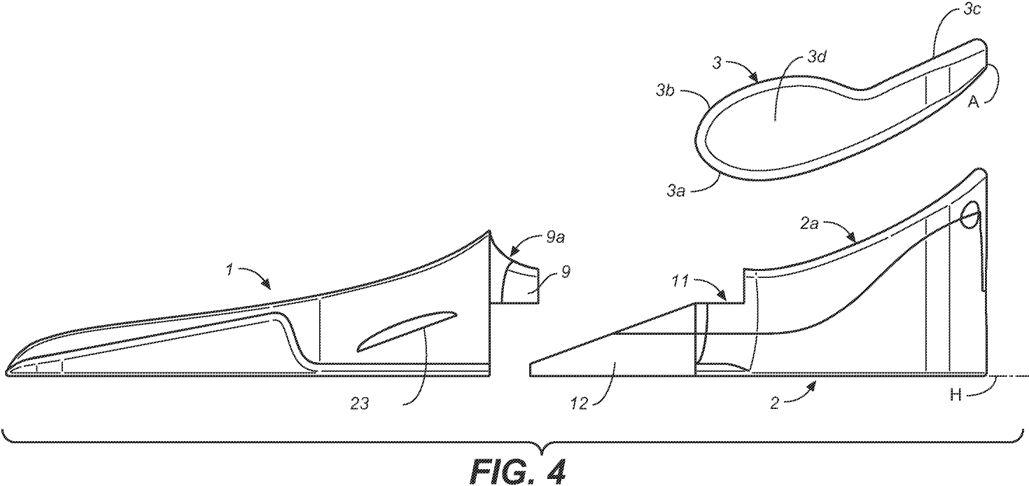

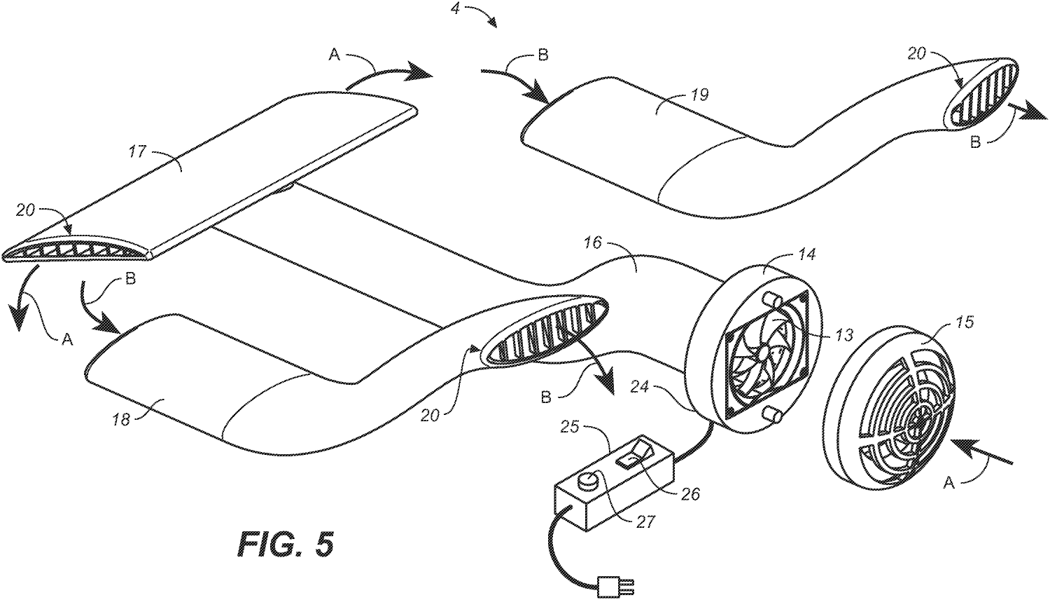

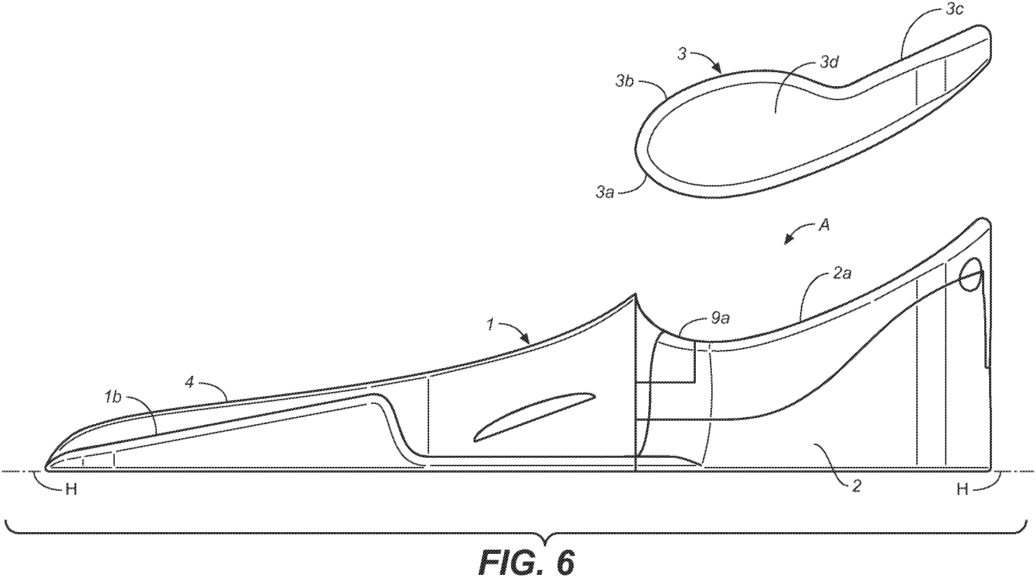

As best shown in FIG. 4, the traction pillow comprises a torso support part 1, an underlay part 2, a pillow part 3, and, as best shown in FIG. 5, a cooling system 4. Specifically, as best shown in FIG. 2b, torso support part 1, gradually increases the torso’s height, generally starting from the hips and ending at the shoulders, as best shown in FIG. 3, along reference plane A or compressed reference plane Aₚᵣᵢₘₑ to elevate the shoulders to a designed height above horizontal plane H, such that the unsupported outer extremities of the upper torso, including the shoulders hang suspended. Shown in FIG. 6, torso support part 1 joins with underlay part 2 to form an inclined elevated resting and mounting surface, acting along reference plane A, for underpinning pillow part 3 to thereby support and align a resting head and neck with an inclined resting torso along reference plane Aₚᵣᵢₘₑ. As best shown in FIG. 1, cooling system 4 circulates relatively cooler ambient air C through an inner core of the traction pillow and into an open volume of space situated below the elevated outer extremities of the upper torso, as best shown in FIG. 2b, to extract heat from the surrounding materials and remove warmer air W from that volume of open space, respectively.

### III. Multi-Tier Geometry

The traction pillow of the present invention is designed to collectively support the human torso, neck, and head in a manner that maintains alignment of the lumbar, thoracic, and cervical spines, enable gravity induced traction across the upper anterior torso, and induce comfortable support to the sleeper, by permitting support surfaces to vertically compress. To achieve this, the proposed traction pillow must overcome the significant weight difference between the weight of the human torso being supported and the combined weight of the head and neck also being supported. According to de Leva (1996), the average torso makes up 43.02% of the total body weight, whereas the combined weight of the head and neck only averages 6.87% of the total body weight. This is based on an average across both male and female genders, where the average male torso comprises 43.46% of total body weight with the head and neck being 6.94% of the total body weight; and where the average female torso makes up 42.58% of total body weight, with the head and neck being 6.81% of the total body weight.

This significant difference in weight creates a set of unique challenges that must be addressed to successful implement the intended objectives and utility of the present invention. Consider for illustration, a hypothetical version of the present invention in which the material properties of the traction pillow are uniform throughout - i.e., the bulk modulus is constant. The bulk modulus defines how the strain within a given material behaves in response to a stress being applied in the form of pressure. Described another way, the bulk modulus defines how much a material will resist elastic deformation, respond in degree of push back, and or how much it will volumetrically compress when the weight of a body rests on its surface. In this hypothetical case, when under the compressive stress of a resting torso and a resting head and neck, portions of the traction pillow will compress to different amounts due to the substantial weight difference between the body’s torso being supported and its head and neck also being supported, causing the part that supports the torso — e.g., the torso support part 1 of the present invention — to deform or compress more in comparison to that of the part that supports the head and neck - e.g., the pillow part 3 of the present invention. This can lead to the thoracic spine in the upper torso and the cervical spine in the neck becoming misaligned. This approach can also make it more difficult to properly support one part of the body, for instance the torso, without over supporting another part, for example, the head and neck. The degree of material firmness required to support the torso, in this case, would likely be too firm or hard for the head and neck. Conversely, if the material properties were uniformly re-formulated to have a bulk modulus that produces a degree of material firmness and material deformation that properly supports the head and neck, the section that supports the torso would likely not provide adequate support due to the reduction in its material firmness and the subsequent increase in its material deformation. Also, in this case, the weight of the torso will likely volumetrically compress this section to an angle below reference plane Aₘₐₓ or in worst case become fully deformed - i.e., volumetrically compresses to a height that allows the posterior part of the shoulders to make contact with a horizontal surface H. In either case, the effect would negate the objectives and intended utility of the present invention.

For these reasons, the torso support part 1, the underlay part 2, and the pillow part 3, of the present invention, are conceived as separate primary parts of the traction pillow, to enable the bulk modulus for each primary part to be independently formulated to produce customized levels of material firmness and material deformation based on its utility - i.e., the amount of weight that each part must support and the degree of comfort it must provide. This flexibility enables each primary part to function independently and collectively as a single integral unit to optimally encourage traction across the upper anterior torso, maintain spinal alignment, and enable the material composition of each primary part to materially deform or compress to dispense an appropriate level of comfort to the part of the body it supports, while providing the required level of material firmness to collectively maintain spinal alignment, based on the amount of weight being supported. Each primary part can be mechanically fastened to each other to form a fully assembled piece as implied above or optionally blended into a single amalgamated part during the manufacturing process.

### IV. General Requirements

The multi-tier design approach governs that each primary part functions independently and collectively according to the following rules:
Rule #1 - Position and maintain the upper torso at a height that permits the outer extremities of the upper torso to hang freely without obstruction above a horizontal plane H at a height generally between 3 to 18 inches to encourage gravity induced traction across the upper anterior torso;
Rule #2 - In compliance with Rule #1, precisely provide the appropriate levels of material firmness or pushback to establish and maintain alignment of the torso, being of higher weight, with the head and neck, being of relative lower weight, such that spinal alignment of the lumbar, thoracic, and cervical spines is maintained;
And Rule #3 - In compliance with Rule #1 and Rule #2, enable each primary part responsible for providing support - i.e., the torso and the head and neck - to volumetrically compress to dispense the appropriate level of comfort to the supported torso and to the supported head and neck, respectively.

### V. Weight Bearing Specifications

Each primary part of the present invention performs a role that collectively satisfies the rules established above. These roles are as follows:
1) a primary role of torso support part 1 is to bear the combined weight of the abdomen, the thorax, the left and right shoulders, and the upper left and right arms, which according to de Leva (1996) and Plagenhoef et al. (1983), is on average 33.23% of a person’s total body weight. The weight of the pelvis which makes up from 13.66% to 15.96% of a person’s torso weight is not included in this compilation, which explains the reduction from 43.02% cited in Section III;
2) a primary role of pillow part 3 is to bear the weight of the head and neck, which according to de Leva (1996), constitutes on average 6.87% of a person’s total body weight;
3) a combined role of the torso support part 1 and the pillow part 3 is to maintain the weight bearing relations - i.e., weight bearing ratio (WBR)_{torso/pillow} - between each other in order to maintain spinal alignment during volumetric compression. The WBR_{torso/pillow} is calculated using equation, WBR_{torso/pillow} = PBₜₒᵣₛₒ/PBW_{head-neck}. Applying the weight bearing percentages employed above for the torso support part 1 and the pillow part 3, the WBR_{torso/pillow} required to satisfy the objectives and utility of the present invention for a body of average size, based on de Leva (1996) and Plagenhoef et al. (1983), is approximately 4.8, which means the torso support part 1 is required to generally support 4.8 times more weight than pillow part 3.

To accommodate body types not of average size, for example, a person having an above average torso weight, the value for the variable PBWₜₒᵣₛₒ is increased to represent the larger percentage of total body weight, resulting in a higher WBR_{torso/pillow}. The preformulation process determines the value of the WBR_{torso/pillow} to be used to formulate the mechanical properties of the materials used to construct the torso support part and mechanical properties of the materials used to construct the pillow part for a specific weight class - e.g., small, medium, large, etc. It is important to note that this scenario emphasizes the relevance of decoupling the utility of the present invention into three primary parts whereby, in this instance, the material properties of the torso support part 1 can be independently scaled, by adjusting its bulk modulus, to satisfy the objectives and utility of the present invention for a body type having an above average torso weight.

TABLE 1

| | Target | Unit | Test Method | Potential Range | Unit |
|---|---|---|---|---|---|
| WBR_{torso/pillow} | 4.8 | n/a | n/a | 2.9 to 7.34 | n/a |

In Table 1, the rightmost two columns demonstrate potential range of weight bearing ratios - i.e., (WBR) between the torso support part 1 and the pillow part 3;
4) another combined role of the torso support part 1 and the pillow part 3 is to volumetrically compress to induce a suitable level of comfort to the torso and a suitable level of comfort to the head and neck that is independent of the mechanical properties of the underlay part 2;
5) a primary role of underlay part 2 is to enable the torso support part 1 and the pillow part 3 to perform their roles by holding the underside of the torso support part 1 and underside of pillow part 3 at a fixed vertical position relative to a horizonal resting plane H, thereby requiring a bulk modulus value and or a compressive strength value that produces a preferable rigid to semirigid underlay part 2.

### VI. Bulk Modulus Specifications and Relations

The mechanical properties that define the bulk modulus of the materials used to construct the primary parts are defined in relation to the following:

First, the mechanical properties of the materials used to construct the torso support part 1 and the pillow part 3 are independently formulated to produce elastic behaviors and pushback characteristics relative to each other that permits each primary part to volumetrically compress in lockstep along reference plane Aₚᵣᵢₘₑ to maintain relative positional alignment between the respective support surfaces, when being simultaneously acted upon by differing stressors, representing the weight of the torso, and representing the weight of the head and neck.

Second, for a given body weight, the mechanical properties of the materials used to construct the torso support part 1 and the pillow part 3 are independently formulated to establish within each material composition an elastic yield point that is designed to be reached when the upper support surface of that primary part is compressed to a level where reference plane Aₚᵣᵢₘₑ collimates with reference plane Aₘₐₓ- i.e., compressed angle α_{ca} is equal to the maximum compressed angle α_{mca}. There may be instances when the inherent properties of the raw materials chosen for manufacturing the primary parts may not allow the material compositions for each primary part, when compressed, to simultaneously reach their respective yield points at reference plane Aₘₐₓ. Still, in such cases, one primary part must have a yield point that peaks at reference plane Aₘₐₓ and the second primary part must have a yield point that peaks after or beyond reference plane Aₘₐₓ.

Third, for a given weight category, the elastic properties of the materials used to construct the torso support part 1 and the pillow part 3 are formulated to produce levels of material firmness and pushback within each material composition that proportionately satisfies the weight bearing ratio (WBR)_{torso/pillow} required to maintain alignment between the torso, head and neck.

TABLE 2

| | | Target | Unit | Test Method | Potential Range | Unit |
|---|---|---|---|---|---|---|
| 1 | Torso Support Part | | | | | |
| | Bulk Modulus _{100 lbs}. | 84 | psf | ASTM D3574 - 11, Test B | 50 to 135 | psf |
| | Bulk Modulus ₁₅₀ _{lbs}. | 185 | psf | ASTM D3574 - 11, Test B | 135 to 221 | psf |
| | Bulk Modulus _{200 lbs}. | 256 | psf | ASTM D3574 - 11, Test B | 221 to 284 | psf |
| | Bulk Modulus ₂₅₀ _{lbs}. | 312 | psf | ASTM D3574 - 11, Test B | 284 to 340 | psf |
| 2 | Pillow Part | | | | | |
| | Bulk Modulus | 76 | psf | ASTM D3574 - 11, Test B | 63 to 101 | psf |
| 3 | Underlay Part | | | | | |
| | Bulk Modulus | 3,496 | psf | ASTM D3574 - 11, Test B | 312 to 4,196 | psf |

In Table 2, the rightmost two columns demonstrate potential ranges of bulk moduli related to each primary part.

Fourth, the mechanical properties of the material used to construct underlay part 2 are formulated to create elastic characteristics within its material composition that respond with negligible or near negligible volumetric compression when a compressive force produced by a resting human body is applied across the torso support part 1 and the pillow part 3.

Integrating the above, the relations between the bulk moduli of the primary parts are as follows: the bulk modulus for the underlay part 2 is greater than the bulk modulus of torso support part 1; and the bulk modulus of torso support part 1 is greater than the bulk modulus for pillow part 3. In rare instances, the bulk modulus of torso support part 1 can be equal to the bulk modulus of pillow part 3. Furthermore, the relative physical positions of each primary part with respect to each other, has the torso support part 1 resting atop of the underlay part 2 with the pillow part 3 also resting atop of the underlay part 2. In both instances, the bulk modulus of the primary part resting atop is lower than the bulk modulus of the primary part positioned below. These relations define the material elasticity constraints that must be complied with to meet the intended objectives and utility of the present invention. These relational constraints are employed during the premanufacturing phase, when material parameters, which includes the bulk modulus, for a given weight classification, are determined for each primary part. As such, these relational constraints are expressed as Bulk Modulus Boundaries (BMBs) and shown in Table 3.

TABLE 3

| Constraint Number | Bulk Modulus Relational Constraints |
|---|---|
| 1 | BMB_{torso/pillow} = BMₜₒᵣₛₒ / BM_{pillow} ≥ 1 |
| 2 | BMB_{torso/underlay} = BMₜₒᵣₛₒ / BM_{underlay} < 1 |
| 3 | BMB_{pillow/underlay} = BM_{pillow} / BM_{underlay} < 1 |

In Table 3, relational constraint #1 states that the bulk modulus boundary — i.e., BMB_{torso/pillow} — between the torso support part 1 and pillow part 3 must be greater than or equal to one; relational constraint #2 states that the bulk modulus boundary — i.e., BMB_{torso/underlay} — between the torso support part 1 and underlay part 2 must be less than one; and relational constraint #3 states that the bulk modulus boundary - i.e., BMB_{pillow/underlay} -between the pillow part 3 and underlay part 2 must be less than one. All three constraints must be satisfied in order to meet the intended objectives and utility of the present invention.

### VII. Indentation Force Deflection (IFD) and Support Factor (SF) Specifications

The bulk modulus requirements for each primary part are translated into a standard system of measure. As such, two important parameters utilized by the mattress industry to describe a foam and its mechanical properties are employed - i.e., Indentation Force Deflection (IFD) and Support Factor (SF).

IFD is a measure of foam firmness and shows how much force a foam pushes back with when a user pushes into it. ASTM D3574, Test B protocols uses 25% IFD as the norm for comparison. Thus accordingly, an IFD 5 foam (5 pounds of pushback) feels softer than a IFD 10 foam (10 pounds of pushback).

SF is a measure of the “deeper” support of a foam, and is an indicator as to whether a foam will bottom out or not. SF is the quotient of the 65% IFD to the 25% IFD - i.e., the ratio of the force required to depress a foam test sample to 65% of its original height to the force required to depress a foam test sample to 25% of its original height (the standard IFD measurement). SF illustrates how much a single type of foam pushes back the more the user pushes into it. Thus, a foam with a SF of 3 and an IFD of 5 pushes back with 15 pounds force upon 65% compression, while an IFD 5 foam with a SF of 2 only pushes back with 10 pounds at 65% compression.

The torso support part 1 is a contoured volume of latex foam. The torso support part 1 may consist of a polyurethane foam and may have the mechanical properties shown in Table 4.

TABLE 4

| | Target | Unit | Test Method | Potential Range | Unit |
|---|---|---|---|---|---|
| Density | 3.3 | pcf | n/a | 1.5 to 6.0 | pcf |
| 25% IFD | 40 | Ib | ASTM D3574 - 11, Test B | 12 to 50 | Ib |
| Support Factor | 2.6 | n/a | ASTM D3574 - 11, Test B | 1.5 to 3.2 | n/a |

In Table 4, the rightmost two columns demonstrate potential ranges of mechanical properties related to the torso support part 1. Furthermore, the target data represents a 200-pound resting body in this embodiment.

The pillow part 3 is a contoured volume of latex foam. The pillow part 3 may consist of a viscoelastic foam and may have the mechanical properties shown in Table 5.

TABLE 5

| | Target | Unit | Test Method | Potential Range | Unit |
|---|---|---|---|---|---|
| Density | 6.0 | pcf | n/a | 2 to 7 | pcf |
| 25% IFD | 12.47 | Ib | ASTM D3574 - 11, Test B | 8 to 20 | lb |
| Support Factor | 2.6 | n/a | ASTM D3574 - 11, Test B | 1.5 to 3.2 | n/a |

In Table 5, the rightmost two columns demonstrate potential ranges of mechanical properties related to the pillow part 3.

The underlay part 2 provides underneath support to the torso support part 1 and the pillow part 3 and may consist of 1.5 pounds per cubic foot rigid to semirigid material - e.g., polypropylene thermoplastic polymer to a polyurethane foam - and may have the mechanical properties shown in Table 6.

TABLE 6

| | Target | Unit | Test Method | Potential Range | Unit |
|---|---|---|---|---|---|
| Density | 1.5 | pcf | n/a | 1 to 4 | pcf |
| Compressive Strength | 40 | psi | ASTM 695 | 19 to 59 | psi |

In Table 6, the rightmost two columns demonstrate potential ranges of mechanical properties related to the underlay part 2.

Each primary part performs a separate function and must work collectively in compliance with the operational rules established in Section IV, General Requirements. For example, Rule #2 mandates alignment between the lumbar, thoracic, and cervical spine be maintained throughout a simultaneous volumetric compression of the torso support part 1 and pillow part 3. This is achieved by first, establishing a level of pushback by the torso support part 1 and a level of pushback by the pillow part 3 that properly aligns the torso with the head and neck, reflected here in the equation 25% IFDR_{torso/pillow}= 25% IFDₜₒᵣₛₒ/ 25% IFD_{pillow}, and second, maintain that alignment throughout the volumetric compression of both primary parts. This is achieved by retaining a constant SF Ratio (SFR). Described another way, maintain proportionate SF values between the torso support part 1 and the pillow part 3. Described yet another way, the difference or degree in pushback provided by each primary part is maintained throughout volumetric compression.

The IFD relation between the torso support part 1 and the pillow part 3 at 25% compression and the relation between their respective Support Factors (SF) are shown in Table 7.

TABLE 7

| | Target | Unit | Test Method | Potential Range | Unit |
|---|---|---|---|---|---|
| 25% IFDR_{torso/pillow} | 3.3 | n/a | ASTM D3574 - 11, Test B | 1.0 to 4.7 | n/a |
| SFR_{torso/pillow} | 1.0 | n/a | ASTM D3574 - 11, Test B | 0.85 to 1.15 | n/a |

In Table 7, the right most two columns demonstrate potential ranges of the mechanical properties and pushback relations between the torso support part 1 and the pillow part 3.

### VIII. Primary Part Geometry

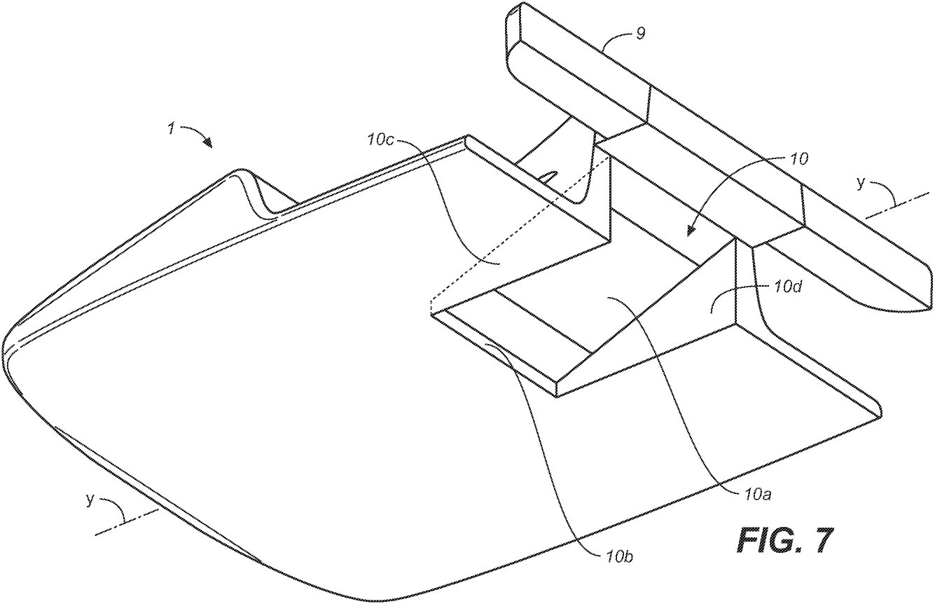

As best shown in FIG. 1 and FIG. 7, torso support part 1 is a single integral piece, consisting of a foam core or similar material, and comprising several subparts described hereafter.

As best shown in FIG. 1, the torso support part 1 is generally an inclined resting surface, acting along reference plane A, as shown in FIG. 3, comprising a middle torso support subpart 5, and having, as best shown in FIG. 6, an upper surface that generally patterns the natural curvature of the lumbar spine and thoracic spine, as best shown in FIG. 1, a right lower torso support subpart 6, a left lower torso support subpart 7, a right upper torso extremities bay subpart 8, and a left upper torso extremities bay subpart 9. As best shown in FIG. 4, the torso support part 1 further comprises a forward pillow support subpart 10 that overlaps with underlay part 2 to thereby jointly support pillow part 3. And, as best shown in FIG. 7, torso support part 1 contains a mortise subpart 11 for interlocking with underlay part 2.

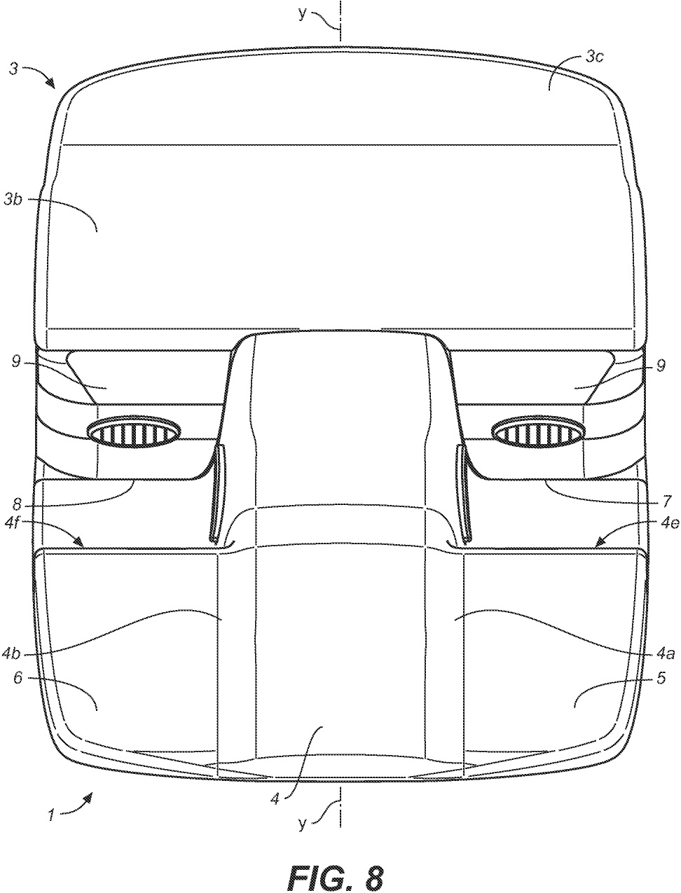

As best shown in FIG. 8, middle torso support subpart 5 is centrally positioned along centerline axis Y, with an upper surface that is relatively flat across its width and having a lower right surface 5a and lower left surface 5b that slopes laterally outward, relative to centerline axis Y, and downward to blend with the upper surface belonging to right lower torso support subpart 6 and to blend with the upper surface belonging to left lower torso support subpart 7, respectively. As best shown in FIG. 8, upper right surface 5c and upper left surface 5d of middle torso support subpart 5 slopes laterally outward, relative to centerline axis Y, and downward, out of reference plane A, to blend respectively with right horizontal surface 6a and to blend with left horizontal surface 7a to create right upper torso extremities bay subpart 8 and left upper torso extremities bay subpart 9, respectively.

As best shown in FIG. 7, mortise subpart 11 is an open cavity that is symmetrically recessed into the rear vertical surface of torso support part 1, along centerline axis Y, comprising an upper sloped surface 11a that intersects with a front vertical surface 11b, a right vertical wedge-shaped surface 11c, a left vertical wedge-shaped surface 11d to form a general wedge-shaped opening having a rear vertical open face and bottom horizontal open face.

As best shown in FIG. 4, forward pillow support subpart 10 has an upper curved surface 10a that reciprocally contours to the lower surface 3a of pillow part 3.

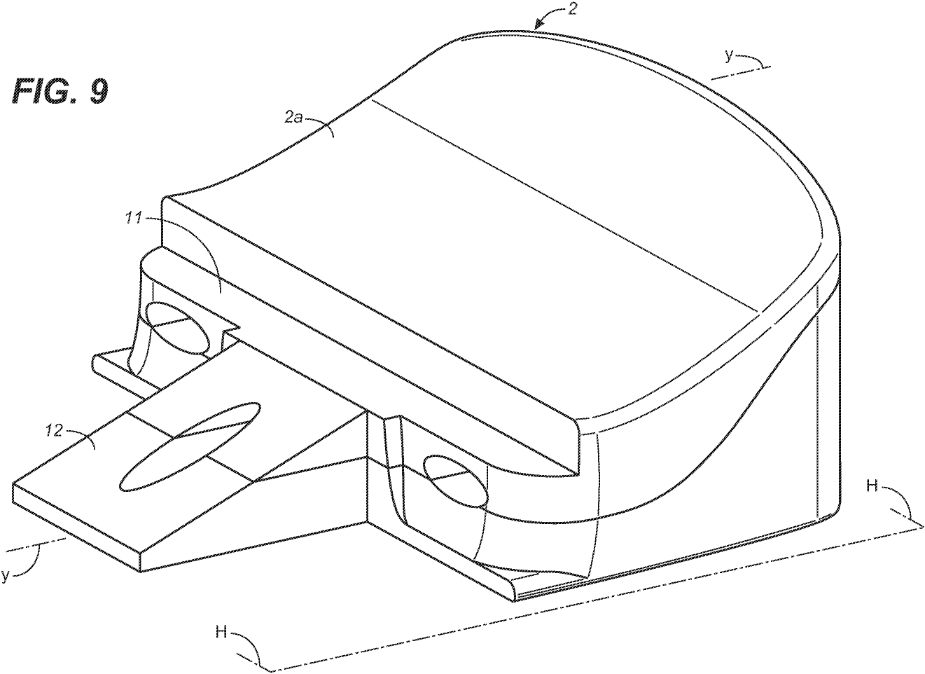

As best shown in FIG. 9, underlay part 2 is generally conceived as a single integral piece, consisting of a foam core or similar material, and comprising several subparts described hereafter.

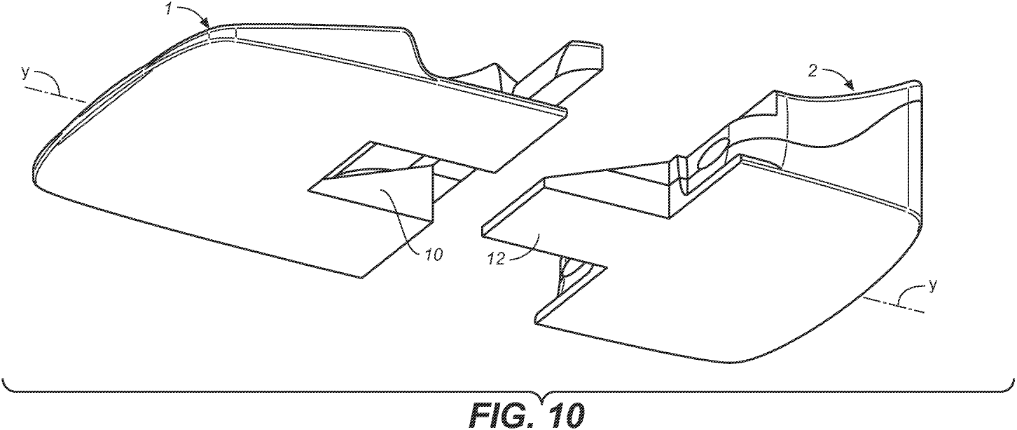

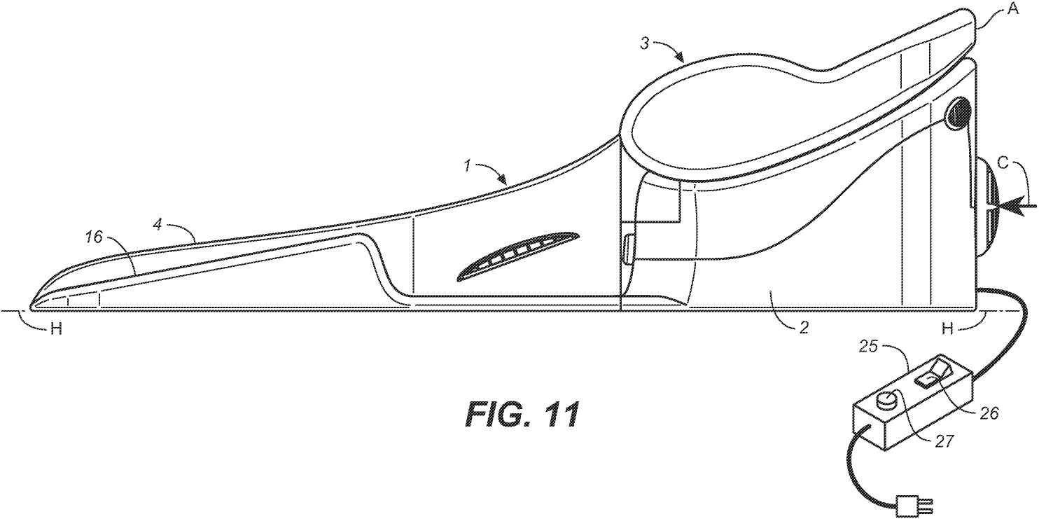

As best shown in FIG. 9, underlay part 2 comprises a ledge subpart 12 for interfacing and configuring with forward pillow support subpart 10 to create a lap joint between underlay part 2 and torso support 1. As best shown FIG. 10, underlay part 2 further consists of a tenon subpart 13 for extending the utility of underlay part 2 underneath the upper central section of torso support part 1 and for slotting, along centerline axis Y, into mortise subpart 11 to interlock with torso support part 1. And, as shown in FIG. 9, underlay part 2 still further comprises a contoured upper surface 2a that interfaces, as best shown in FIG. 6, with upper curved surface 10a of forward pillow support subpart 10 to integrally form an upper surface that inversely contours with lower surface 3a to interface with and, as best shown in FIG. 11, underpin pillow part 3.

As best shown in FIG. 5, cooling system 4 comprises a suction motor 14, a suction motor box 15 for housing suction motor 14, a suction motor box vent 16, an inlet duct 17, an airflow splitter 18, a right exhaust duct 19, a left exhaust duct 20, and an electric cable 21 with an inline controller 22 having a power switch 23 and variable speed controller 24 to connect with a power source (not shown). Each duct and airflow splitter 18 opening is fitted with a vent 25.

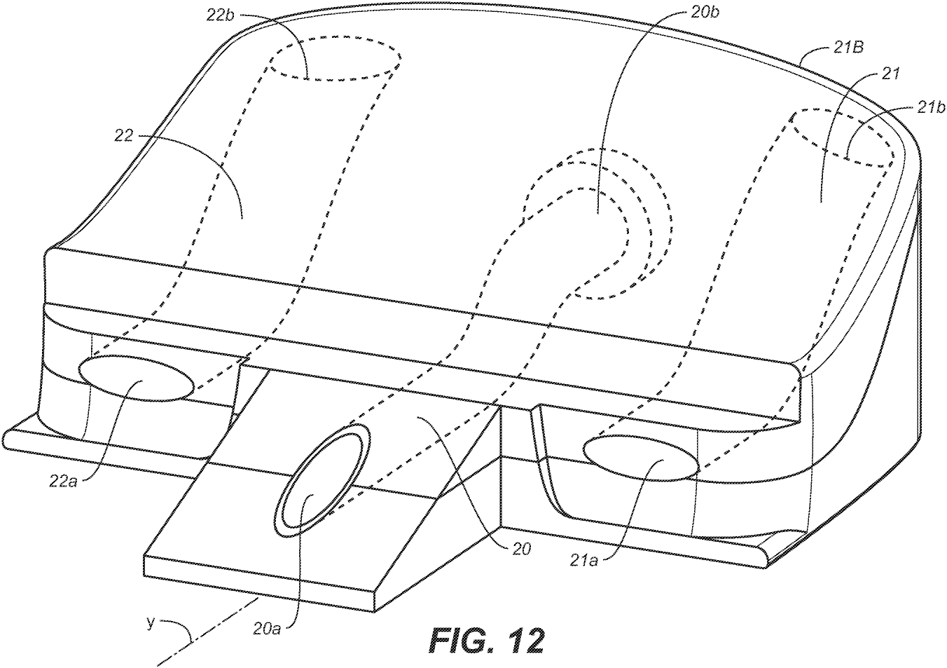

As best shown in FIG. 12, underlay part 2 yet further comprises, for inclusion of cooling system 4, an embedded centrally positioned tunnel 26 along centerline axis Y which has a forward opening 26a and rear opening 26b for housing inlet duct 17, and suction motor box 15. Still additionally, underlay part 2 comprises an embedded right tunnel 27 having a forward opening 27a and rear opening 27b for accommodating right exhaust duct 19 and an embedded left tunnel 28 having a forward opening 28a and rear opening 28b for accommodating left exhaust duct 20. Right tunnel 27 and left tunnel 28 are oppositely positioned and equally spaced laterally relative to centerline axis Y.

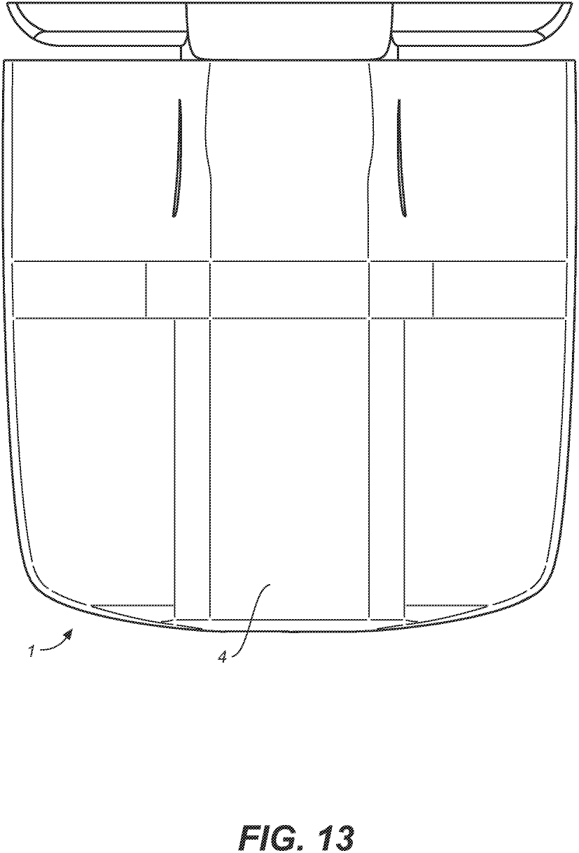

Also, as best shown in FIG. 13, the upper right surface 5c and upper left surface 5d of torso support part 1 further comprises, for inclusion of cooling system 4, an identical right and left opening 29 for accommodating airflow splitter 18.

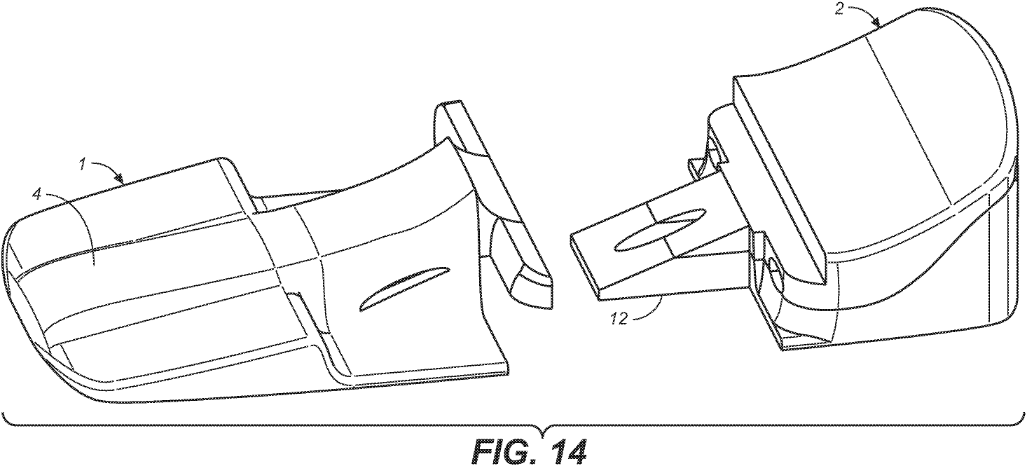

The underlay part 2 can be designed and manufactured as a bifurcated part that splits along internal tunnels to enable easier installation of cooling system 4 components described above. Furthermore, as best shown in FIG. 14, underlay part 2 can also be conceived as a single integral piece, not comprising internal housing for accommodating components, for example, those belonging to cooling system 4.

Still further, the geometric relations between the mortise subpart 11 and tenon subpart 13 can be scaled such that the tenon subpart 13 is further extended underneath and into the body of torso support part 1 to expand the utility of the tenon subpart 13 or shorten to in effect decrease the utility of tenon subpart 13.

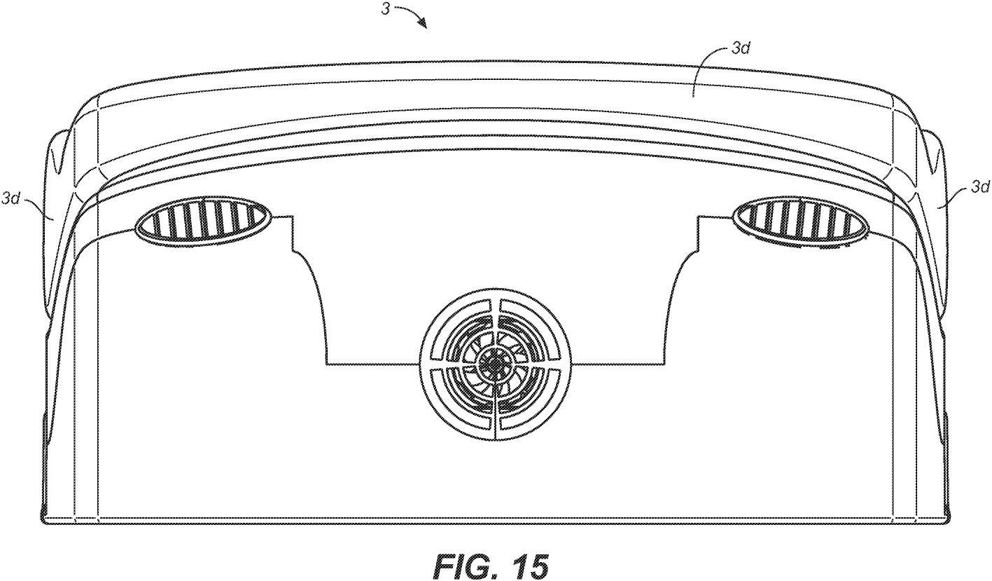

As best shown in FIG. 6, pillow part 3 has a curved upper surface 3b that resembles the natural curvature of the neck and a generally flat upper surface 3c for supporting the head. Cooperatively, upper surface 3b and upper surface 3c support the neck and head respectively such that the cervical spine is in proper alignment with the thoracic and lumbar spines being supported by torso support part 1. As best shown in FIG. 6, upper surface 3b and upper surface 3c joins with the upper edge of vertical surface 3d and lower surface 3a joins with the lower edge of vertical surface 3d to form, as shown in FIG. 15, an enclosed volume consisting of a foam core or similar material.

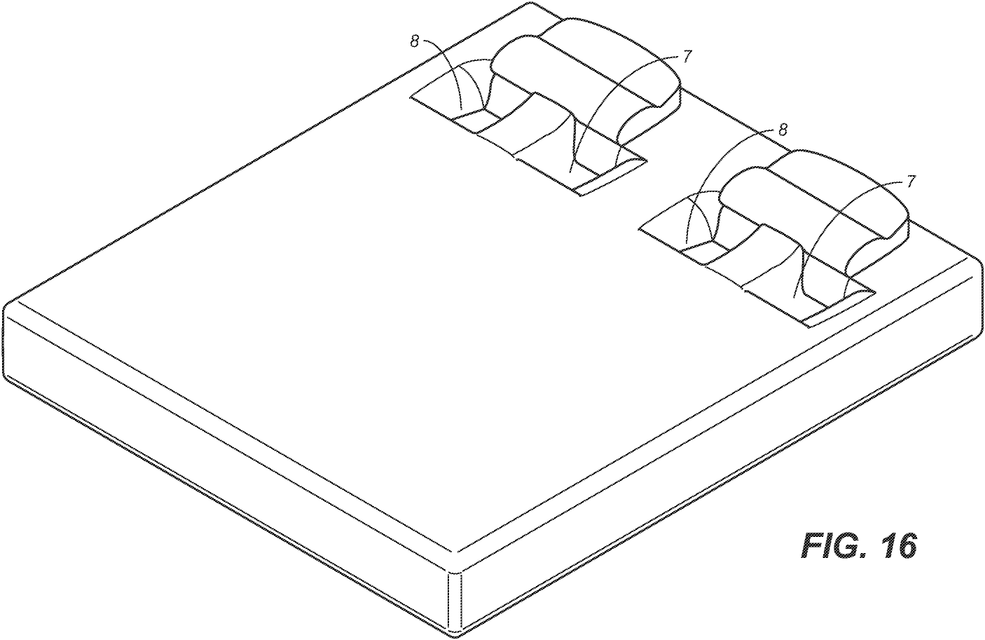

The present invention includes an outer casing (not shown) for covering the traction pillow, which can be easily removed for washing or be alternatively switched out to present a different color and or style. It’s important to note that the primary parts can be constructed of the same materials or of different materials, and can be either fused together to form a single unit or as separate individual components assembled in a stacked configuration. Alternatively, as best shown in FIG. 16, the traction pillow of the present invention can be integrated into a conventional sleeping apparatus, such as a mattress, to integrally function as single sleeping apparatus. In this adaptation, the right upper torso extremities bay subpart 7, and the left upper torso extremities bay subpart 8 of the present invention are embedded into the horizontal surface of the mattress to enable the outer extremities of the upper torso, including the shoulders and the upper arms, to hang suspended.

### USE AND OPERATION

In order to use the traction pillow of the current invention, the user first places the traction pillow onto a horizontal surface such a bed. Facing away and sitting at the edge of the traction pillow, the user aligns the center of their back with the middle torso support subpart 5. The user then lies back onto the traction pillow in a supine position, placing their head onto pillow part 3. As a consequence, the outer regions of the lower torso will align and rest on the right lower torso support subpart 6 and the left lower torso support subpart 7. The upper torso will be elevated above the bed, thereby enabling the right outer extremities of the upper torso to hang suspended above the right upper torso extremities bay subpart 8 and enabling the left outer extremities of the upper torso to hang suspended above left upper torso extremities bay subpart 9. The middle torso support subpart 5, the curved upper surface 3b, and the flat upper surface 3c will orient the lower and upper regions of the torso, the neck, and the head in positions that puts the least amount of stress and strain on the lumbar, thoracic and cervical spines. Gravity will pull the outer extremities of the upper torso, including the shoulders, downward and into the open space of the right upper torso extremities bay subpart 8 and into the open space of the left upper torso extremities bay subpart 9 to induce traction across the upper anterior torso, thereby stretching the muscles within this region of the body over an average eight (8) hour period of sleep, with the goal of reversing the effects of bad daily habits. During the same period of time, the posterior muscles of the upper torso, in a relaxed state, will begin to retract towards their normal length. The torso support part 1 and the pillow part 3 volumetrically compresses to provide comfortable support while spinal alignment is maintained and gravity induced traction across the upper anterior torso is applied. Working in unison with primary parts, torso support part 1 and pillow part 3, underlay part 2 holds the lower surfaces belonging to torso support part 1 and belonging to pillow part 3 at a fixed inclined angle relative to a horizontal surface or bed, thereby preventing the upper torso from sinking below a height that prevents the outer extremities of the upper torso from hanging suspended above the surface of the bed or other resting surface. The user can use the inline controller 22 to activate the cooling system 4 via the power switch 23 and can vary the cooling rate by using the variable speed controller 24. Upon activation, the suction motor 14 pulls ambient air A into inlet duct 17 from the surrounding environment. The cooler ambient air A travels through inlet duct 17 and into the airflow splitter 18 for equal dispersion into the right upper torso extremities bay subpart 8 and left upper torso extremities bay subpart 9. The bifurcated right-side airflow and left-side airflow then flows into the right exhaust duct 19 and left exhaust duct 20, respectively, to be reintroduced into the ambient environment. As the cooler ambient air A removes body heat released into the upper torso extremities bay subparts and extracts body heat absorbed by the internal core materials through thermal convection, the parts of body supported by the traction pillow are cooled.

As can be seen from the above, the traction pillow of the present invention is versatile, simple to use, and employs a modular scaling methodology that enables its primary parts to be manufactured to different specifications to accommodate different weight classifications - i.e. different ranges of weights.

While this invention has been described as having a preferred design, it is understood that it is capable of further modifications, uses, and or adaptations of the invention following in general the principle of the invention and including such departures from the present disclosure as come with known or customary practice in the art to which the invention pertains, and as may be applied to the central features hereinbefore set forth and fall with the scope of the invention or the limits of the claims appended hereto.

What I claim is:

1. An upper torso traction apparatus, comprising:
a. a means for suspending the outer extremities of the upper torso, including the shoulders together with the upper arms, above a surface;
b. an open bay means into which the suspended outer extremities of the upper torso, including the shoulders together with the upper arms, are enabled to droop unobstructed or virtually unobstructed;.

2. The upper torso traction apparatus as in claim 1, comprising:
a. an inclined support means for elevating the upper torso above a horizontal resting surface;.

3. The upper torso traction apparatus as in claim 2, wherein:
a. the inclined support means elevates the outer extremities of the upper torso approximately between 3 to 18 inches above the horizontal resting surface;.

4. The upper torso traction apparatus as in claim 2, wherein the inclined support means comprises:
a. a torso support means for supporting the torso part of a human body;
b. a pillow means for supporting a head together with a neck of a human body;
c. an underlay means for underpinning the torso support means together with underpinning the pillow means;.

5. The upper torso traction apparatus as in claim 4, wherein the torso support means comprises:
a. a central support element for longitudinally supporting a middle region of the torso;
b. a left lateral support element for supporting a left outer region of a lower torso;
c. a right lateral support element for supporting a right outer region of a lower torso;
d. a left side open bay means, laterally adjoining the central support element, longitudinally positioned between the lower left lateral support element and the pillow means, into which the suspended outer left side extremities of the upper torso, including the left shoulder together with the left upper arm, are enabled to droop unobstructed or virtually unobstructed;
e. a right side open bay means laterally, adjoining the central support element, longitudinally positioned between the lower right lateral support element and the pillows means, into which the suspended outer right side extremities of the upper torso, including the right shoulder together with the right upper arm, are enabled to droop unobstructed or virtually unobstructed;
f. a mortise element, longitudinally positioned along centerline-axis Y, for enabling the underlay means to underpin the torso support means;.

6. The upper torso traction apparatus as in claim 5, wherein the central support element comprises:
a. a lower section that is anatomically contoured to the natural curvature of the lumbar spinal column;
b. an upper section that is anatomically contoured to the natural curvature of the thoracic spinal column;.

7. The upper torso traction apparatus as in claim 4, wherein the pillow means comprises:
a. a neck support section that is anatomically contoured to the natural curvature of the cervical spinal column;
b. a head support section that is generally flat;.

8. The upper torso traction apparatus as in claim 4, wherein the underlay means comprises:
a. a mounting surface for underpinning the pillow means;
b. a base structure for orienting the mounting surface into alignment with the torso support means along reference plane A;
c. a tenon element, frontally adjoining the base structure, along centerline-axis Y, for underpinning the torso support means along reference plane A;.

9. The upper torso traction apparatus as in claim 2, wherein the inclined support means and including:
a. A cooling system means for transferring cooler air into the inclined support means, together with extracting heat from the inclined support means;.

10. The upper torso traction apparatus as in claim 9, wherein the cooling system means comprises:
a. an inlet duct means for transporting an airstream of cooler ambient air, together with extracting heat from surrounding materials to mix with the cooler airstream;
b. an airflow splitter means for directing the cooler ambient air to different locations within the open bay means;
c. a left exhaust duct means for transporting released body heat from the open bay means, together with extracting heat from surrounding materials to mix with the cooler airstream;
d. a right exhaust duct means for transporting released body heat from the open bay means, together with extracting heat from surrounding materials to mix with the cooler airstream;
e. a suction motor for introducing ambient air into the inlet duct means;
f. a suction motor box for housing the suction motor;
g. a controller for activating-deactivating the cooling system means, together with regulating airstream flow;.

11. The upper torso traction apparatus as in claim 4, wherein the torso support means and including:
a. an embedded conduit means for housing the airflow splitter means;.

12. The upper torso traction apparatus as in claim 4, wherein the underlay means and including:
a. an embedded central conduit means for housing the inlet duct means;
b. an embedded left conduit means for housing the left exhaust duct means;
c. an embedded right conduit means for housing the right exhaust duct means;.

13. The upper torso traction apparatus as in claim 1, and including:
a. a mattress;
b. wherein the open bay means is embedded into the mattress into which the outer extremities of the upper torso, including the shoulders together with the upper arms, are enabled to droop unobstructed or virtually unobstructed;.

14. The upper torso traction apparatus as in claim 13, wherein:
a. the open bay means comprises a left open bay means, longitudinally positioned along the length of the mattress, into which the left outer extremities of the upper torso, including the left shoulder together with the upper left arm, are enabled to droop unobstructed or virtually unobstructed;
b. the open bay means comprises a right open bay means, longitudinally positioned along the length of the mattress, into which the right outer extremities of the upper torso, including the right shoulder together with the upper right arm, are enabled to droop unobstructed or virtually unobstructed;.

15. The upper torso traction apparatus as in claim 14, wherein:
a. the left open bay means has a lateral width of approximately at least 4 inches;
b. the right open bay means has a lateral width of approximately at least 4 inches;
c. the left open bay means has a longitudinal length of approximately between 4 to 14 inches;
d. the right open bay means has a longitudinal length of approximately between 4 to 14 inches;
e. the left open bay means has a depth of approximately between 3 to 10 inches;
f. the right open bay means has a depth of approximately between 3 to 10 inches;.

16. An inclined sleeping apparatus, comprising:
a. a torso support means generally positioned at the lower end of the inclined sleeping apparatus for supporting the torso part of a human body, a pillow means generally positioned at the upper end of the inclined sleeping apparatus for supporting a head, together with supporting a neck of a human body, and an underlay means for underpinning the torso support means together with underpinning the pillow means;
b. wherein the torso support means comprises compressible material generally having the mechanical properties of latex foam;
c. wherein the pillow means comprises compressible material generally having the mechanical properties of a polyurethane foam;
d. wherein the underlay means comprises generally rigid to semirigid material;
e. wherein the support factor ratio, the quotient of the torso support means support factor divided by the pillow means support factor, is approximately between 0.85 to 1.15;.

17. The inclined sleeping apparatus as in claim 16, wherein:
a. the compressible material for constructing the torso support means comprises a polyurethane foam or similar behaving material having a support factor of approximately between 1.5 to 3.2;
b. the compressible material for constructing the pillow means comprises a viscoelastic foam or similar behaving material having a support factor of approximately between 1.5 to 3.2;
c. the rigid to semirigid material for constructing the underlay means comprises mechanical properties approximately between that of polypropylene thermoplastic polymer to polyurethane foam;.

18. The inclined sleeping apparatus as in claim 16, wherein;
a. the underlay means orients the torso support means, together with orienting the pillow means, along reference plane A, for gradually elevating a torso, a neck, together with a head of a supine resting human body above a horizontal resting surface;
b. the torso support means comprises a means for suspending the outer extremities of the upper torso, including the shoulders together with the upper arms, above the horizontal resting surface;
c. the torso support means comprises an open bay means into which the suspended outer extremities of the upper torso, including the shoulders together with the upper arms, are enabled to droop unobstructed or virtually unobstructed above a lower surface;.

19. An inclined sleeping apparatus, comprising:
a. a torso support means generally positioned at the lower end of the inclined sleeping apparatus for supporting the torso part of a human body, a pillow means generally positioned at the upper end of the inclined sleeping apparatus for supporting a head, together with supporting a neck of a human body, and an underlay means for underpinning the torso support means together with underpinning the pillow means;
b. wherein the underlay means orients the torso support means, together with orienting the pillow means, along reference plane A, for gradually elevating a torso, a neck, together with a head of a supine resting human body above a horizontal resting surface;
c. wherein the torso support means comprises a means for suspending the outer extremities of the upper torso, including the shoulders together with the upper arms, above the horizontal resting surface;
d. wherein the torso support means comprises an open bay means into which the suspended outer extremities of the upper torso, including the shoulders together with the upper arms, are enabled to droop unobstructed or virtually unobstructed;
e. wherein the torso support means comprises a compressible material generally having the mechanical properties of latex foam;
f. wherein the pillow means comprises a compressible material generally having the mechanical properties of a polyurethane foam;
g. wherein the underlay means comprises generally rigid to semirigid material;
h. wherein the torso support means’ bulk modulus is approximately greater than the pillow means’ bulk modulus;.

20. The inclined sleeping apparatus as in claim 19, wherein:
a. the torso support means has a bulk modulus of approximately between 50 to 340 pounds per square foot;
b. the pillow means has a bulk modulus of approximately between 63 to 101 pounds per square foot;
c. the underlay means has a bulk modulus of approximately between 312 to 4,126 pounds per square foot;.

21. The inclined sleeping apparatus as in claim 19, wherein:
a. the torso support means’ bulk modulus is approximately less than the underlay means’ bulk modulus;
b. the pillow means’ bulk modulus is approximately less than the underlay means’ bulk modulus;.

22. The inclined sleeping apparatus as in claim 19, wherein:
a. the torso support means’ bulk modulus is approximately equal to the pillow means’ bulk modulus;.

23. The inclined sleeping apparatus as in claim 19, wherein:
a. the torso support means’ 25% indentation force deflection is approximately greater than the pillow means’ 25% indentation force deflection;.

24. The inclined sleeping apparatus as in claim 19, wherein:
a. the torso support means’ 25% indentation force deflection is approximately equal to the pillow means’ 25% indentation force deflection;.

25. An inclined sleeping apparatus, comprising:
a. a torso support means generally positioned at the lower end of the inclined sleeping apparatus, a pillow means generally positioned at the upper end of the inclined sleeping apparatus, and an underlay means generally positioned underneath the torso support means together with the pillow means;
b. the underlay means orients the torso support means, together with orienting the pillow means, along reference plane A, for gradually elevating a torso, a neck, together with a head of a supine resting human body above a horizontal resting surface;
c. the torso support means comprises a means for suspending the outer extremities of the upper torso, including the shoulders together with the upper arms, above the horizontal resting surface;
d. the torso support means comprises an open bay means into which the suspended outer extremities of the upper torso, including the shoulders together with the upper arms, are enabled to droop unobstructed or virtually unobstructed;
e. wherein the torso support means comprises a volume of compressible material generally having the mechanical properties of latex foam for supporting the torso part of a human body;
f. wherein the pillow means comprises a volume of compressible material generally having the mechanical properties of a polyurethane foam for supporting a head, together with supporting a neck of a human body;
g. wherein the underlay means comprises a volume of generally rigid to semirigid material for underpinning the torso support means together with underpinning the pillow means;
h. wherein the torso support means has a 25% indentation force deflection of approximately at least 12 pounds;.

26. The inclined sleeping apparatus as in claim 25, wherein:
a. the torso support means has a density of approximately between 2 to 6 pounds per cubic foot;
b. the torso support means has a 25% indentation force deflection of approximately between 12 to 50 pounds;
c. the torso support means has a support factor of approximately less than 3.2;
d. the pillow means has a density of approximately between 3 to 7 pounds per cubic foot;
e. the pillow means has a 25% indentation force deflection of approximately between 8 to 20 pounds;
f. the pillow means has a support factor of approximately less than 3.2;
g. the underlay means has a density of approximately less than 4 pounds per cubic foot;
h. the underlay means has a compressive strength of approximately greater than 19 pounds per square inch;.

27. The inclined sleeping apparatus as in claim 25, wherein:
a. the volume of compressible material for supporting the torso, the volume of compressible material for supporting the head, together with supporting the neck, the volume of rigid to semirigid material for underpinning the torso support means, together with underpinning the pillow means, amalgamates into a single volume of material comprising three amalgamated material subvolumes wherein the encompassed material within each amalgamated material subvolume comprising mechanical properties possessing pushback characteristics that behave independent of adjacent amalgamated material subvolumes;.
